(19) United States
(12) Patent Application Publication
(10) Pub. No.: US 2008/0021517 A1
(43) Pub. Date: Jan. 24, 2008

(54) AUDIOLOGICAL TRANSMISSION SYSTEM

(75) Inventor: Stefan Dietrich, Erlangen (DE)

Correspondence Address: LUCAS & MERCANTI, LLP, 475 PARK AVENUE SOUTH, 15TH FLOOR, NEW YORK, NY, 10016, US

(73) Assignee: CERBOMED GMBH, ERLANGEN (DE)

(21) Appl. No.: 11/778,693

(22) Filed: Jul. 17, 2007

(30) Foreign Application Priority Data
Jul. 18, 2006 (DE) 10 2006 036 069.9

(51) Int. Cl. H04R 25/00

(52) U.S. Cl. 607/57

(57) ABSTRACT

The invention relates to an audiological transmission system (1) which is designed to be worn on, in or behind the human ear and has a housing (2), an electrical amplifier (3), a loudspeaker (4) and an output channel (5) for acoustic signals for the ear. In order to advantageously enhance the functionality of such a transmission system, the invention provides for the transmission system (1) to also have a device (6) for transcutaneous stimulation of a nerve of the human body, said device having at least one stimulation electrode (7) and at least one reference electrode (8) for transcutaneous nerve stimulation.

The invention relates to an audiological transmission system which is designed to be worn on, in or behind the human ear and has at least one housing, an electrical amplifier, a loudspeaker and an output channel for acoustic signals for the ear.

Various audiological apparatuses of the generic type are known. Such apparatuses are usually referred to as “hearing aids”. They are used to improve the hearing ability of a person afflicted with or suffering from hearing loss by acoustically amplifying noises to a sound level that is suitable for the person wearing the hearing aid. For example, the spoken word is thus electronically amplified and the amplified signal is delivered to the ear of the person who is hard of hearing and who can thus hear better again. Furthermore, functions, for example masking ambient and interfering noises, are realized using a wide variety of algorithms which are usually implemented using a microprocessor.

Another type of audiological transmission system, so called “tinnitus maskers” or “tinnitus noisers” or “tinnitus instruments”, is used to improve the situation of patients who have noises in their ears. These are noises, sounds or other acoustic qualities which the affected person “hears” but whose production is not based on a real sound source. These are also referred to as “phantom noises”. For the purpose of alleviation, an apparatus which produces sounds or noises of particular acoustic qualities and delivers them to the ear is worn behind, on or in the ear. Such a “noise generator” is intended to cover up the phantom noises and thus make them more bearable.

Apparatuses for transcutaneous nerve stimulation which use invasive or non-invasive electrical stimulation of nerves to influence the neuroelectrical quality of the latter and thus the function of the nerves to be stimulated have also been disclosed. The aim of this approach is usually to incite psychovegetative changes, for example stress relief, or to treat neuropsychiatric disorders.

In the case of the previously known solutions, the following circumstance has proven to be disadvantageous in particular:

An apparatus which can be used both in the case of hardness of hearing or tinnitus problems and in the case of neurological, neuropsychiatric or psychosomatic problems has not previously been disclosed.

Hearing defects and, in particular, noises in the ears which, as described, can be treated with so-called tinnitus maskers are frequently associated with psychosomatic disorders, for example depressive moods, depression, sleep disorders etc.

Depression has been successfully treated in the past using invasive stimulation of the vagus nerve, in particular. In this case, a stimulator which generates current pulses and thus results in a change in the neurophysiological quality of the vagus nerve is implanted in the left-hand region of the patient's neck using neurosurgery. As shown in numerous studies, stimulation of the vagus nerve has positive effects on syndromes such as epilepsy and depression.

Implantological stimulation has proven to be disadvantageous in numerous aspects. These include, in particular, the operation risk associated with invasive introduction, the risk of nerve damage and a risk of infection which is associated with the operation. In addition, the patients have a feeling of “being extraneously controlled”. The high costs of such a stimulator and of the operation and the necessary infrastructure should also be mentioned.

Non-invasive stimulation of the vagus nerve has occasionally been described but the previously known solutions sometimes provided only an unsatisfactory result.

For extensive use of both methods, that is to say a conventional audiological transmission system and the transcutaneous stimulation of the vagus nerve, it is desirable to integrate both technologies in a small and manageable apparatus which, as far as possible, can be worn on, in or behind the ear and can be worn at any time without complication and in an inconspicuous manner.

Therefore, on the basis of an audiological system of the type mentioned initially, the invention is based on the object of proposing such an apparatus so that said desire can be satisfied. The intention is to provide an apparatus which, on the one hand, is used for transcutaneous, simple and efficient nerve stimulation and, on the other hand, has all the requirements and features of a conventional audiological transmission system. The aim is to integrate both systems in one apparatus and for both systems to be able to be used both in a manner dependent on one another and independent of one another. A high gain in therapeutic value is intended to be achieved by combining both methods and systems.

The achievement of this object by the invention is characterized in that the audiological transmission system mentioned initially is distinguished by the fact that it also has a device for transcutaneous stimulation of a nerve of the human body, said device comprising at least one stimulation electrode and at least one reference electrode for transcutaneous nerve stimulation.

In this case, the device for transcutaneous stimulation of a nerve is preferably an integral part of the transmission system.

The functions of the audiological transmission system are preferably accommodated in a modular manner in a housing which is designed to be fitted on, in or behind the human ear. Provision may be made for both systems, that is to say the stimulation system and the transmission system, to be combined on a printed circuit board. Provision may also be made for the circuits and printed circuit board of the transmission apparatus to be considered to be a base to which a second module containing the circuit and the printed circuit board of the stimulation apparatus can be applied in an irreversible or reversible manner. This may be effected, for example, using a slot plug-in connection or other variants.

In this case, the apparatus is designed and is suitable, in particular, for stimulating the vagus nerve in the region of the external auditory canal and/or the auricle.

Provision is preferably made for at least one electronic or mechanical control element of the audiological transmission system and at least one electronic or mechanical control element of the device for transcutaneous nerve stimulation to be in the form of a common module. Both at least one parameter of the transmission system and at least one parameter of the stimulation device can be set and adapted to the needs of the person wearing the apparatus using such a module. In the event of a change in one parameter, for example in the transmission system, one development provides for at least one stimulation parameter of the stimulation unit to be automatically changed in accordance with a particular dependent algorithm without further assistance. This algorithm may be stored in a common memory chip, for example a microprocessor or a flash. However, the settings may also be made in an analogue manner, for example using connected potentiometers.

Rather than being integrated in the housing of the acoustic transmission system, another development provides for the device for transcutaneous stimulation of a nerve to have its own housing which can be connected to the housing of the transmission system by means of a wireless, cable-type or other connection, for example a plug-in connection. To this end, the housing of the transmission system is designed in such a manner that it comprises at least one connection point for connection to the device for nerve stimulation or comprises a wireless receiver or other receiver for connection to the device for nerve stimulation. The connection between the two systems can be configured to be releasable, temporarily releasable or fixed.

Provision may also be made for the housing of the stimulation device to be in the form of a clip system which can be connected to the transmission system in a reversible or irreversible manner. The clip may have its own power supply or, when connected to the transmission system, may also take the power supply for the latter.

Provision may also be made for the module for transcutaneous nerve stimulation to contain an additional circuit which can use a microchip, for example, to record, evaluate or otherwise process information from at least one sensor which is intended to measure physiological parameters (for example oxygen saturation of the blood, heart rate variability) or other parameters and is fitted to the human body. This additional circuit may also be fitted to the printed circuit board of the audiological transmission system independently of the stimulation module or connected to said transmission system in another manner.

The audiological transmission system according to the invention may be characterized in that the transmission system has, in the region of the output channel for acoustic signals, a bow-shaped extension which can be coupled or is coupled there and is designed to be inserted into the auditory canal, the bow-shaped extension matching the shape of the ear or of the entrance to the auditory canal or the external auditory canal, and an electrode head which has at least one stimulation electrode being arranged at the end of the bow-shaped extension beside an opening for outputting acoustic signals.

A reference electrode may be arranged beside the stimulation electrode but may also be situated at another point of the apparatus. One development of the invention also provides for at least one sensor for measuring physiological or environmental parameters to be situated at the end of the bow-shaped extension beside an opening for outputting acoustic signals and the electrode head, said sensor either being connected to the surface of the body and/or to the environment or else being embedded in the end of the bow-shaped extension without contact with the surroundings.

The bow-shaped extension may be hollow in the form of a tube and may have an opening for outputting acoustic signals. However, it may also have a cable connection which leads to an externalized loudspeaker which is situated in the electrode head.

In terms of materials, the electrode head can be configured in a wide variety of ways. The electrodes are advantageously flat surface electrodes made of carbon fibres, stainless steel, conductive plastic and may be coated with a sponge-like material having graphite inserts, inter alia, in order to improve the electrical conductivity. The electrodes may be set into the electrode head, which is made, for example, of perspex, silicones, ceramics, metals or other biocompatible materials, in a fixed manner or by pushing it.

If the electrode head is inserted, the electrodes touch the surface of the skin and may stimulate parts of the nerves situated there, on the one hand, and it is possible to acoustically output a sound to the ear, on the other hand.

An exemplary embodiment of the invention is shown in the drawing, in which:

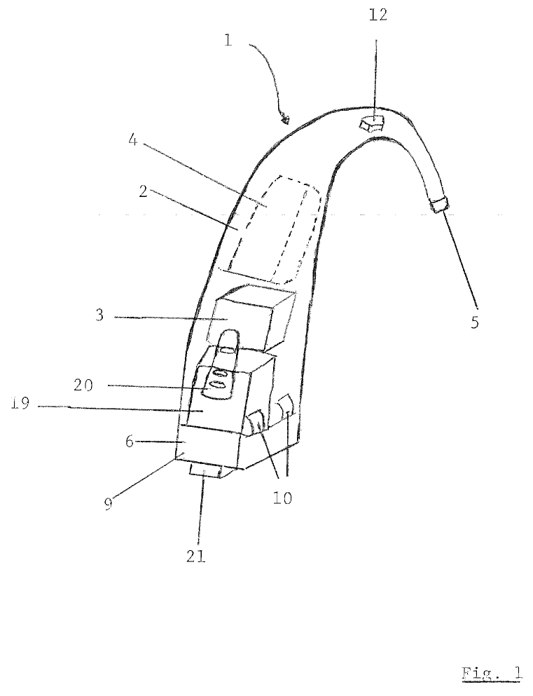

FIG. 1 shows a perspective view of an audiologlcal transmission system with an integrated device for stimulation of the vagus nerve,

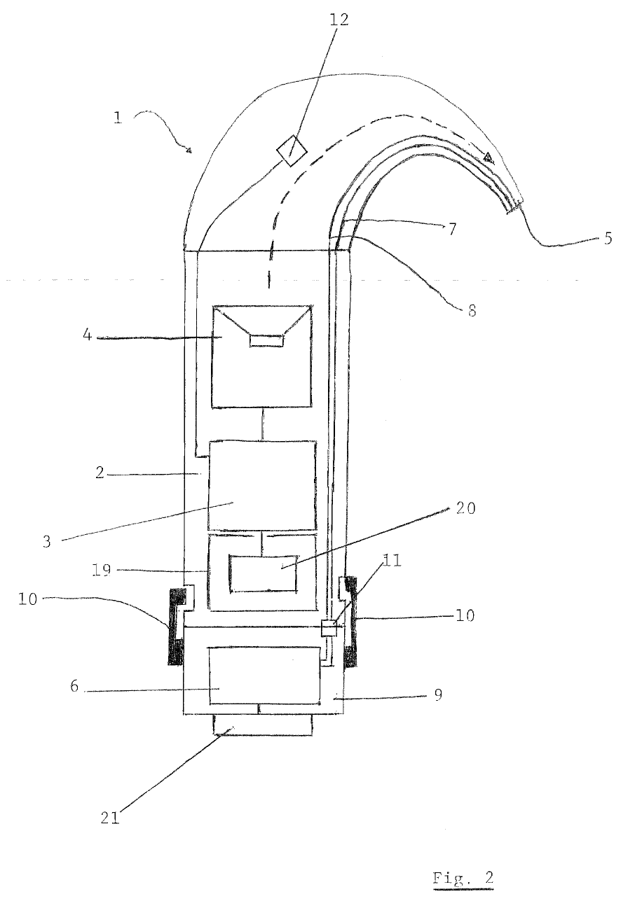

FIG. 2 shows a longitudinal section of the audiological transmission device with individual core components, and

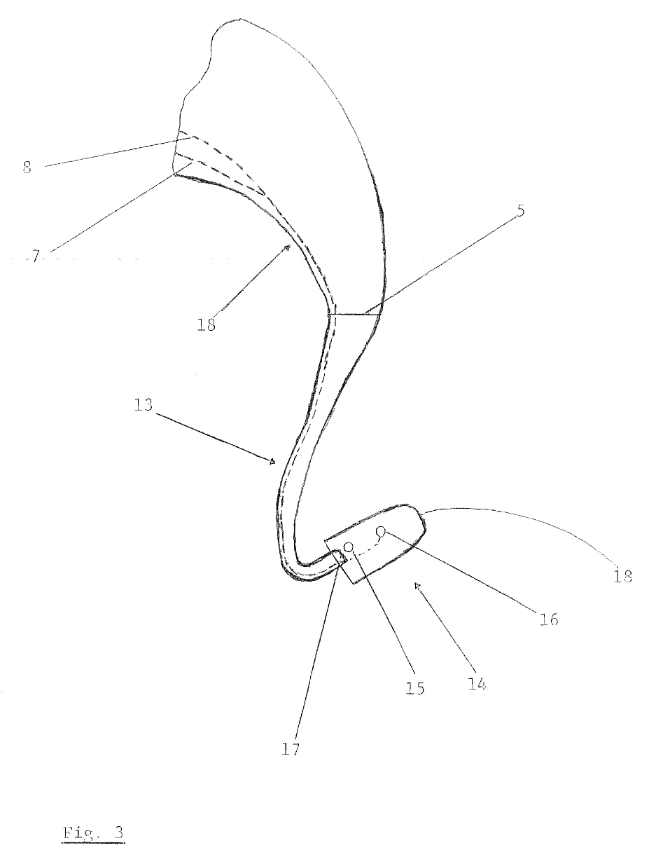

FIG. 3 shows a perspective view of one end region of the audiological system with a bow-shaped extension and an electrode head.

The design of an audiological transmission system 1 according to the present invention is diagrammatically shown in the figures. The audiological transmission system 1 essentially comprises a housing 2 in which the basic components of a hearing aid are integrated or to which the basic components of a hearing aid are fitted, namely a loudspeaker 4, a microphone 12, an electrical amplifier 3, a battery 19 and a multifunction switch 20 which switches the on/off function, for example.

The housing 2 is configured in such a manner that it has at least one clip connection 10 on the longitudinal side, for example. A device 6 for transcutaneous stimulation of a nerve, which is introduced into a further housing 9, may be fitted to this clip connection 10 in a reversible or irreversible manner. The device 6 may comprise a switch 21 for setting and controlling the stimulation parameters of the device.

The switch 21 and the multifunction switch 20 may also be coupled, so that the parameters of the device 6 may be set using the multifunction switch 20. Provision may likewise be made for the device 6 to be completely integrated in the housing 2.

The sound signals which have been amplified by the electrical amplifier 3 and have been output using the loudspeaker 4 are forwarded using an output channel 5 for acoustic signals.

As can be seen in FIG. 2, the housing 9 of the device 6 for transcutaneous stimulation of a nerve may also be connected to the housing 2 by means of an electrical coupling element (plug and socket connection).

The coupling element 11 is connected to leads for a stimulation electrode 7 and a reference electrode 8. The leads and the electrodes 7, 8 are inside the output channel 5 for acoustic signals, that is to say in a bow-shaped extension 13 which is fastened to the end of the output channel 5.

Details of the bow-shaped extension 13 are illustrated in FIG. 3. As mentioned, one end of the bow-shaped extension 13 is fastened to the end of the output channel 5. An electrode head 14 is arranged at its other end. A sensor 18 may also be accommodated there in addition to the lead and the electrodes 7 and 8.

Provision may also be made for the sensor 18 to be accommodated in the electrode head 14. The electrode head 14 comprises contact points 15 and 16 which are used as stimulation and reference electrodes, that is to say are electrically connected to the leads and electrodes 7, 8. An opening 17 for outputting acoustic signals is also accommodated in the electrode head 14. As mentioned, the electrode head 14 also has a sensor 18.

Provision could also be made for the loudspeaker 4 to be integrated in the electrode head 14.

### LIST OF REFERENCE SYMBOLS

1 Audiological transmission system

2 Housing

3 Electrical amplifier

4 Loudspeaker

5 Output channel for acoustic signals

6 Device for transcutaneous stimulation of a nerve

7 (Lead for the) stimulation electrode

8 (Lead for the) reference electrode

9 Housing

10 Clip connection

11 Electrical coupling element

12 Microphone

13 Bow-shaped extension

14 Electrode head

15 Contact point

16 Contact point

17 Opening for outputting acoustic signals

18 Sensor

19 Battery

20 Multifunction switch (including on/off switch)

21 Switch

1. Audiological transmission system which is designed to be worn on, in or behind the human ear comprising a housing, an electrical amplifier, a loudspeaker and an output channel for acoustic signals for the ear, wherein the transmission system also has a device for transcutaneous stimulation of a nerve of the human body, said device having at least one stimulation electrode and at least one reference electrode for transcutaneous nerve stimulation.

2. Transmission system according to claim 1, wherein the device for transcutaneous stimulation of a nerve is an integral part of the transmission system.

3. Transmission system according to claim 2, wherein at least one electronic control element of the electrical amplifier and at least one electronic control element of the device for transcutaneous stimulation of a nerve are in the form of a common electronic module.

4. Transmission system according to claim 3, wherein the common electronic module comprises a common electronic chip, in particular an electronic printed circuit board.

5. Transmission system according to claim 1, wherein the device for transcutaneous stimulation of a nerve has its own housing which is connected to the housing of the transmission system.

6. Transmission system according to claim 5, wherein the connection between the housing of the device for transcutaneous stimulation of a nerve and the housing of the transmission system is designed to be releasable.

7. Transmission system according to claim 6, wherein the connection is in the form of a clip connection.

8. Transmission system according to claim 6, wherein electrical coupling elements which interact are provided on the housing of the device for transcutaneous stimulation of a nerve and on the housing of the transmission system.

9. Transmission system according to claim 1, further comprising a microphone and said system is in the form of a hearing aid.

10. Transmission system according to claim 1, wherein said system is in the form of a tinnitus masker.

11. Transmission system according to claim 1, wherein a bow-shaped extension which is designed to be inserted into the auditory canal can be coupled or is coupled in the region of the output channel for acoustic signals, the bow-shaped extension matching the shape of the entrance to the auditory canal or the external auditory canal, and an electrode head which has two contact points for the two electrodes being arranged at the end of the bow-shaped extension.

12. Transmission system according to claim 11, wherein the bow-shaped extension is in the form of a tube and has an opening for outputting acoustic signals.

13. Transmission system according to claim 12, wherein the opening is arranged on or in the electrode head.

14. Transmission system according to claim 11, wherein the electrode head is designed and is suitable for stimulating the vagus nerve in the region of the external auditory canal and/or the auricle.

15. Transmission system according to claim 11, wherein the electrode head is made of a soft material, in particular of permanently soft silicone.

16. Transmission system according to claim 11, wherein the contact points are formed by metal balls.

17. Transmission system according to claim 11, wherein the contact points are formed by flat surface electrodes.

18. Transmission system according to claim 11, wherein the contact points are formed by an element made of a material with electrical surface conductivity, in particular of a sponge with graphite inserts.

19. Transmission system according to claim 1, further comprising at least one sensor for measuring a physiological parameter of the person using the transmission system.
